(19) United States
(12) Patent Application Publication
(10) Pub. No.: US 2019/0287166 A1
(43) Pub. Date: Sep. 19, 2019

(54) CAR SHARING SYSTEM, METHOD FOR CAR SHARING, INFORMATION PROCESSING DEVICE, AND NON-TRANSITORY STORING MEDIUM STORING A PROGRAM

(71) Applicant: Toyota Jidosha Kabushiki Kaisha, Toyota-shi Aichi-ken (JP)

(72) Inventors: Koichiro Mitsumaki, Nagoya-shi Aichi-ken (JP); Masato Endo, Nagakute-shi Aichi-ken (JP); Ryota Kondo, Nagoya-shi Aichi-ken (JP); Yasuhisa Obata, Nagoya-shi Aichi-ken (JP)

(73) Assignee: Toyota Jidosha Kabushiki Kaisha, Toyota-shi Aichi-ken (JP)

(21) Appl. No.: 16/354,566

(22) Filed: Mar. 15, 2019

(30) Foreign Application Priority Data
Mar. 19, 2018 (JP) 2018-051115

(51) Int. Cl. G06Q 30/06; G07C 5/08; G06Q 50/30

(52) U.S. Cl. CPC G06Q 30/0645; G06Q 50/30; G07C 5/085

(57) ABSTRACT

A car sharing system includes at least one processor configured to: acquire an evaluation result of a user who uses a vehicle; and set contents of a car sharing service that the user can use from a next time, based on the acquired evaluation result.

### CROSS-REFERENCE TO RELATED APPLICATIONS

This application claims priority to Japanese Patent Application No. 2018-051115 filed on Mar. 19, 2018, which is incorporated herein by reference in its entirety including the specification, drawings and abstract.

### BACKGROUND

### 1. Technical Field

The present disclosure relates to a car sharing system, a method for car sharing, an information processing device, and a non-transitory storage medium storing a program.

2. Description of Related Art

A service called car sharing (hereinafter abbreviated as CS as necessary), which allows a plurality of users to share a single vehicle, is known. In this service, an owner registers himself/herself with the CS service and then sets vehicle rental conditions (e.g., vehicle type, area, available time zone, etc.). On the other hand, a user registers himself/herself with the CS service and then sets vehicle search conditions including an application for using a vehicle. If the vehicle rental conditions set by the owner match the vehicle search conditions set by the user, the CS system, which provides the CS service, notifies the user's terminal about the information on the matched vehicle and permits the user to rent the vehicle.

Recently, to prevent global warming and to improve atmospheric environments, eco-driving is recommended. Based on this background, a new CS system has been proposed that can encourage CS service users to drive environmentally friendly (see, for example, Japanese Patent Application Publication No. 2012-164210 (JP 2012-164210 A)).

### SUMMARY

The system described above evaluates the degree of environmental friendliness of the driving of a user during the CS use time and presents the evaluation result to the user to effectively make the user conscious of eco driving. However, merely feeding back the evaluation result does not directly give a CS user great advantages. Therefore, there is room for improvement as a method for promoting the use of the CS service.

The present disclosure provides a car sharing system that can effectively promote the use of the car sharing service.

A first aspect of the disclosure provides a car sharing system, including at least one processor configured to: acquire an evaluation result of a user who uses a vehicle; and set contents of a car sharing service that the user can use from a next time, based on the acquired evaluation result.

In the first aspect, the at least one processor may be configured to acquire use result information with the evaluation result of the user, the use result information representing a use result of the car sharing service by the user, and set the contents of the car sharing service that the user can use from the next time, based on the evaluation result and the use result information that are acquired.

In the first aspect, the evaluation result of the user may include at least one of an evaluation result sent from an owner of the vehicle and an evaluation result sent from a subsequent user.

In the first aspect, the car sharing system may further include a memory configured to store, for each user, evaluation history information representing a history of the evaluation result. The at least one processor may be configured to acquire the evaluation history information on the user for a predetermined period of time, determine a service rank of the user based on the acquired evaluation history information and, to set, according to the determined service rank, the contents of the car sharing service that the user can use from the next time.

In the first aspect, there may be a service item of the car sharing service that can be used when the determined service rank is a specific service rank.

A second aspect of the disclosure provides a method for car sharing, including: acquiring an evaluation result of a user who uses a vehicle; and setting contents of a car sharing service that the use can use from a next time, based on the acquired evaluation result.

In the second aspect, the method may further include acquiring use result information with the evaluation result of the user, the user result information representing a user result of the car sharing service by the user, and setting the contents of the car sharing service that the user can use from the next time, based on the evaluation result and the use result information.

In the second aspect, the method may further include: storing, for each user, evaluation history information representing a history of the evaluation result, acquiring the evaluation history information on the user for a predetermined period of time; determining a service rank of the user based on the acquired evaluation history information; and setting, according to the determined service rank, the contents of the car sharing service that the user can use from the next time.

A third aspect of the disclosure provides an information processing device including: at least one processor; and a storage device coupled to the at least one processor and storing program instructions which, when executed by the at least one processor, cause the information processing device to perform the method according to the second aspect.

A fourth aspect of the disclosure provides a non-transitory storage medium storing a program. The program, when executed by a computer, causes the computer to function as: an acquisition unit that acquires an evaluation result of a user who uses a vehicle; and a setting unit that sets contents of a car sharing service that the user can use from a next time, based on the acquired evaluation result.

According to the aspects of the present disclosure, the car sharing system that can effectively promote the use of the car sharing service can be provided.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing an example of a configuration of a car sharing system according to an embodiment;

FIG. 2 is a diagram showing an example of a functional block configuration of an information processing device;

FIG. 3 is a diagram showing a specific example of a rental condition DB;

FIG. 4 is a diagram showing a specific example of a use desired-condition DB;

FIG. 5 is a diagram showing a specific example of a use result information DB;

FIG. 6 is a diagram showing a specific example of an evaluation information DB;

FIG. 7 is a diagram showing a specific example of a service rank DB; and

FIG. 8 is a diagram showing an example of a processing procedure performed by the information processing device.

### DETAILED DESCRIPTION OF EMBODIMENTS

Embodiments of the present disclosure is described in detail below with reference to the drawings. In the drawings, the same reference numeral is used for the same or equivalent component.

A. Embodiment

### <Basic Configuration of the System>

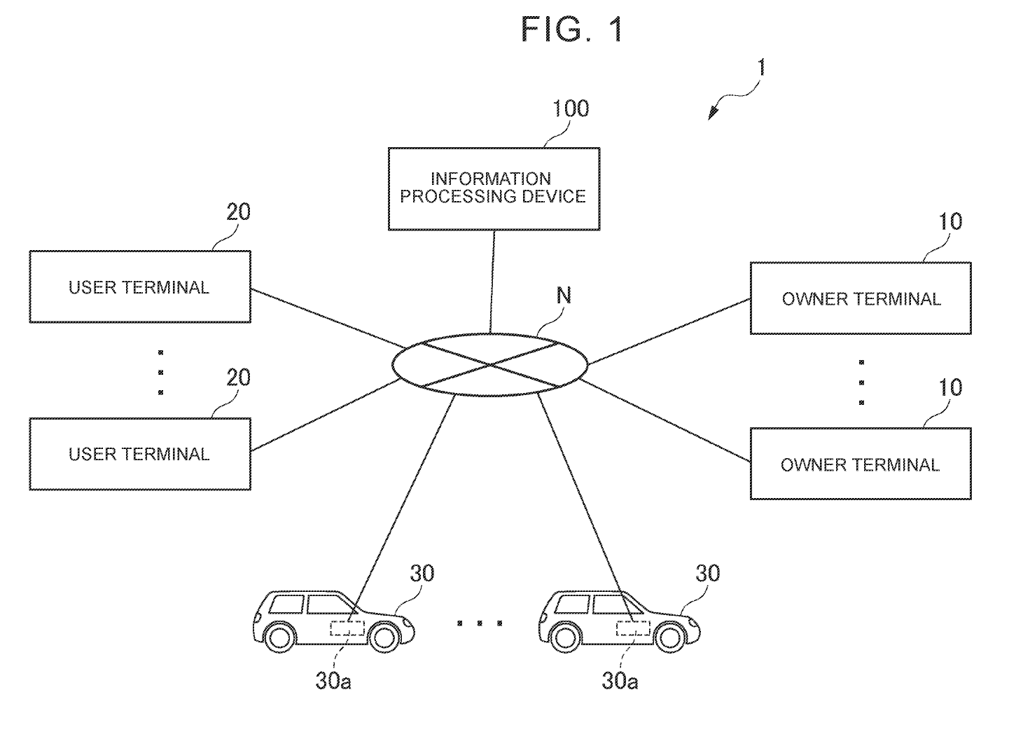

FIG. 1 is a diagram showing an example of a configuration of a CS system 1 according to the embodiment. The car sharing system 1 includes owner terminals 10, user terminals 20, vehicles 30, and an information processing device 100. An in-vehicle device 30a is mounted on each of the vehicles 30. The owner terminal 10, user terminal 20, in-vehicle device 30a, and information processing device 100 can communicate with each other via a communication network N.

<Outline of the CS Service>

The basic flow of the car sharing service (CS service) is described below. An owner (including corporations and individuals) who provides his/her vehicle for rental use enters the owner's basic information (name, sex, age, address, telephone number, SNS account information, transfer account, etc.) using the owner terminal 10 to register himself/herself as an owner. After that, the owner sets the vehicle rental conditions (which will be described later) using the owner terminal 10 and waits for a rental request from a user.

On the other hand, a user who wants to rent a vehicle enters the user's basic information (name, sex, age, address, telephone number, SNS account information, credit card number, etc.) using the user terminal 20 to register himself/herself as a user. After that, the user sets the vehicle use desired-conditions (which will be described later) using the user terminal 20.

The information processing device 100 compares (matches) the vehicle rental conditions, set by an owner, with the vehicle use desired-conditions, set by a user, and performs matching processing. If matching is successful, the information processing device 100 notifies the owner and the user about the successful matching and about the information on the vehicle rental (i.e., CS service) procedure. After that, when the vehicle is actually rented, the information processing device 100 registers the use result information (for example, user ID, vehicle ID, use date and time, use time, travel distance, traveling area, number of use times, etc.) that indicates the use result of each user. This use result information is sent from the in-vehicle device 30a. Furthermore, the information processing device 100 registers the evaluation information on a user who has rented the vehicle (that is, the evaluation result of the user). This evaluation information is sent from the owner terminal 10 of each owner. Details of these pieces of information will be described later.

Based on the use result information and the evaluation information on a user who uses the CS service, the information processing device 100 determines the user's service rank and, based on the determined service rank, sets the service contents that the user can use from the next time. For example, the highest service rank (for example, the platinum rank) is given to a user who has obtained a very high evaluation result, and the benefits specifically defined for the users of that service rank are given to the user (For example, the user can rent a vehicle earlier than the members of other service ranks, the user can rent a certain luxury vehicle preferentially). Setting ranks in this way encourages each user to use the CS service and motivates each user to enhance the evaluation result, making it possible to effectively promote the use of the CS service.

<Device Configuration>

The owner terminal 10, a terminal used by an owner who provides a vehicle for rental use, is a smartphone, a tablet terminal, a wearable terminal, a mobile terminal, a notebook computer, or the like. On the owner terminal 10, the screen for registering an owner with the CS service and the screen for setting vehicle rental conditions are displayed. An owner uses these screens to enter various information for executing the owner registration procedure and the vehicle rental procedure and, in addition, to enter the evaluation information on a user to whom the vehicle was rented.

The user terminal 20, a terminal used by a user who rents a vehicle, is a smartphone, a tablet terminal, a wearable terminal, a mobile terminal, a notebook computer, or the like. On the user terminal 20, the screen for registering a user with the CS service and the screen for setting vehicle use desired-conditions are displayed. A user uses these screens to enter various information for executing the user registration procedure and the desired-vehicle renting procedure.

The vehicle 30 is a vehicle provided by each owner for use in the CS service. The vehicle 30 includes both a car owned by an individual (the owner is an individual) and a car owned by a company (the owner is a cooperation). The vehicle 30 may be of any type as long as it is a vehicle with wheels. More specifically, the vehicle 30 may be a vehicle provided by a company as a rental vehicle for car sharing, a taxi that can be shared, or a vehicle owned by an individual. The vehicle 30 is not limited to an automobile, but may be a large-sized vehicle with a capacity of a dozen to dozens of people such as a bus or may be a motorcycle or a tricycle. The vehicle 30 may be the vehicle 30 in which a user holds the steering wheel for driving (hereinafter also referred to as a “manually-driven vehicle”) or the vehicle 30 that can be driven autonomously (hereinafter referred to as “self-driving vehicle”).

The in-vehicle device 30a, such as a car navigation device, is capable of exchanging various information with the information processing device 100. The in-vehicle device 30a regularly or irregularly sends the use result information, which indicates each user's use result of the vehicle 30, to the information processing device 100. When the vehicle 30 is a manually-driven vehicle, the return location designated by the owner of the vehicle 30 may be registered in advance in the in-vehicle device 30a such as a car navigation device. On the other hand, when the vehicle 30 is a self-driving vehicle, the information on a designated location, as well as the control information for autonomously driving the vehicle 30 to the designated location, is sent from the information processing device 100 to the in-vehicle device 30a.

The information processing device 100 accepts owner registration and user registration that are required for an owner and a user to use the CS service according to the present embodiment. In addition, the information processing device 100 receives the rental condition setting of the vehicle 30 from an owner and registers the received rental conditions in the database. Similarly, the information processing device 100 receives the use desired-condition setting of the vehicle 30 from a user and registers the received use desired-conditions in the database. The information processing device 100 compares (matches) the rental conditions for the vehicle 30, set by an owner, and the use desired-conditions for the vehicle 30, set by a user, to select a user to whom the vehicle 30 is to be rented (i.e., the information processing device 100 performs matching processing).

In addition, after the vehicle 30 is actually rented from the owner, the information processing device 100 registers the use result information in the database. This use result information, which is sent regularly or irregularly from each in-vehicle device 30a, indicates each user's use result of the vehicle 30. At the same time, the information processing device 100 registers the evaluation information (that is, the evaluation result of the user) in the database. This evaluation information, which is sent from the owner terminal 10 of each owner, indicates the evaluation of the user to whom the vehicle was rented. In addition, the information processing device 100 determines the service rank of each user based on the use result information and the evaluation information that have been registered and, according to the determined service rank, sets the service contents that the user can use from the next time. The information processing device 100 may be configured by one or more information processing devices or may be configured using a cloud server or a virtual server.

<Functional Block Configuration>

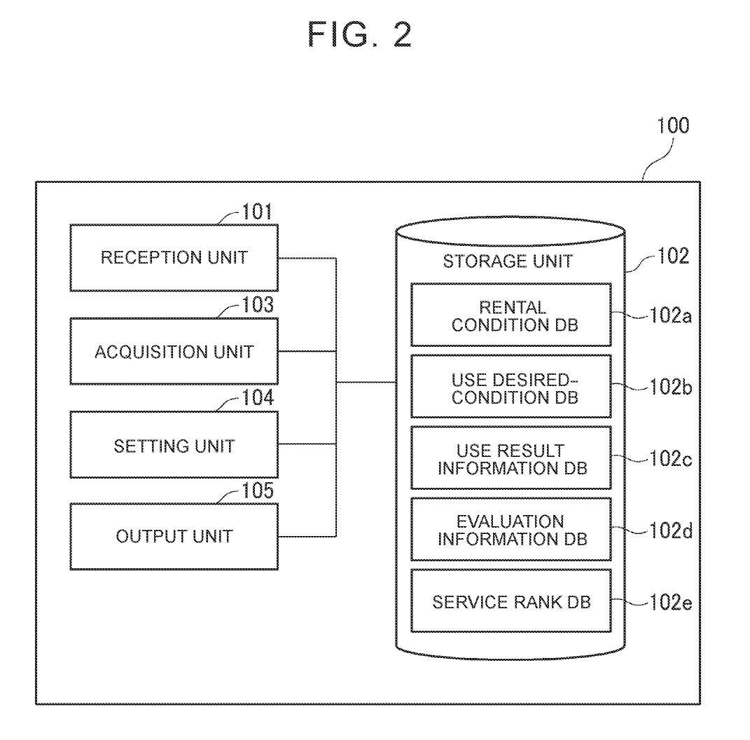

FIG. 2 is a diagram showing an example of a functional block configuration of the information processing device 100. The information processing device 100 includes a reception unit 101, a storage unit 102, an acquisition unit 103, a setting unit 104, and an output unit 105.

Each of the reception unit 101, acquisition unit 103, setting unit 104, and output unit 105 is implemented when one or more CPUs of the information processing device 100 execute the corresponding program stored in the storage unit 102. The programs can be stored in a recording medium. The recording medium in which the programs are stored may be a non-transitory recording medium. The non-transitory recording medium is not limited to a particular recording medium, but may be a recording medium such as a USB memory or a CD-ROM. The storage unit 102 can be implemented using a memory or a storage device provided in the information processing device 100.

The reception unit 101 receives the setting of the rental conditions for the vehicle 30 from each owner and stores the received rental conditions in the storage unit 102. The reception unit 101 also receives the setting of the user evaluation information from each owner and stores the received user evaluation information in the storage unit 102. In addition, the reception unit 101 receives the setting of the use desired-conditions for the vehicle 30 from each user, and stores the received use desired-conditions in the storage unit 102. Furthermore, the reception unit 101 receives the use result information on the vehicle 30 for each user from the in-vehicle device 30a and stores the received use result information in the storage unit 102.

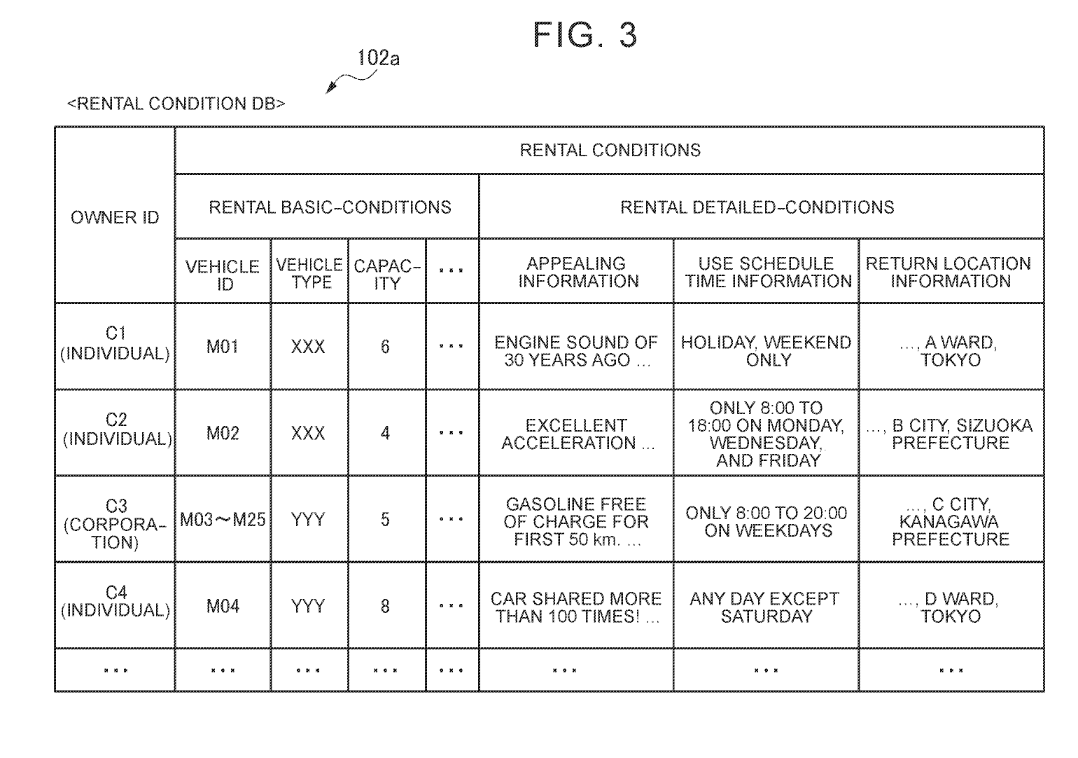

The storage unit 102 includes a rental condition database (DB) 102a, a use desired-condition database (DB) 102b, a use result information database (DB) 102c, an evaluation information database (DB) 102d, and a service rank database (DB) 102e. The contents registered in each DB are described below with reference to FIG. 3 to FIG. 7.

<Rental Condition DB 102a>

FIG. 3 is a diagram showing a specific example of the rental condition DB 102a. As shown in FIG. 3, an owner ID (for example, the name of an owner), which uniquely identifies the owner, and rental conditions are associated with each other and registered in the rental condition DB 102a.

The rental conditions include rental basic-conditions and rental detailed-conditions. The rental basic-conditions include at least the vehicle type. FIG. 3 shows an example of the rental basic-conditions in which the vehicle ID (for example, a vehicle number), which uniquely identifies the vehicle 30, and the information indicating the vehicle type and the riding capacity are included. In addition to the above example, the rental basic-conditions may include information indicating the maker of the vehicle. The rental detailed-conditions include the appealing information, use schedule time information, and return location information. The appealing information is the information that emphasizes the owner's selling point of the vehicle 30 (for example, “excellent acceleration . . . ”). The use schedule time information is the information indicating the time during which the owner uses the vehicle 30 (in other words, the time during which the vehicle is not rented to the user). The return location information is the information indicating the return location of the vehicle 30 specified by the owner.

In the example shown in FIG. 3, as the rental basic-conditions, the owner whose owner ID is “C1 (individual)” has set the vehicle ID “M01”, the vehicle type “XXX”, and the capacity “6”. At the same time, as the rental detailed-conditions, the owner has set the appealing information indicating that “engine sound of 30 years ago . . . ”, the use schedule time information indicating that “holiday, weekend only”, and the return location information indicating that “ . . . , A ward, Tokyo”. Note that, as the return location information, the owner may set not only a location, such as the home, the nearest station, and a parking lot around the house, but also another location (such as a well-known tourist spot).

<Use Desired-condition DB 102b>

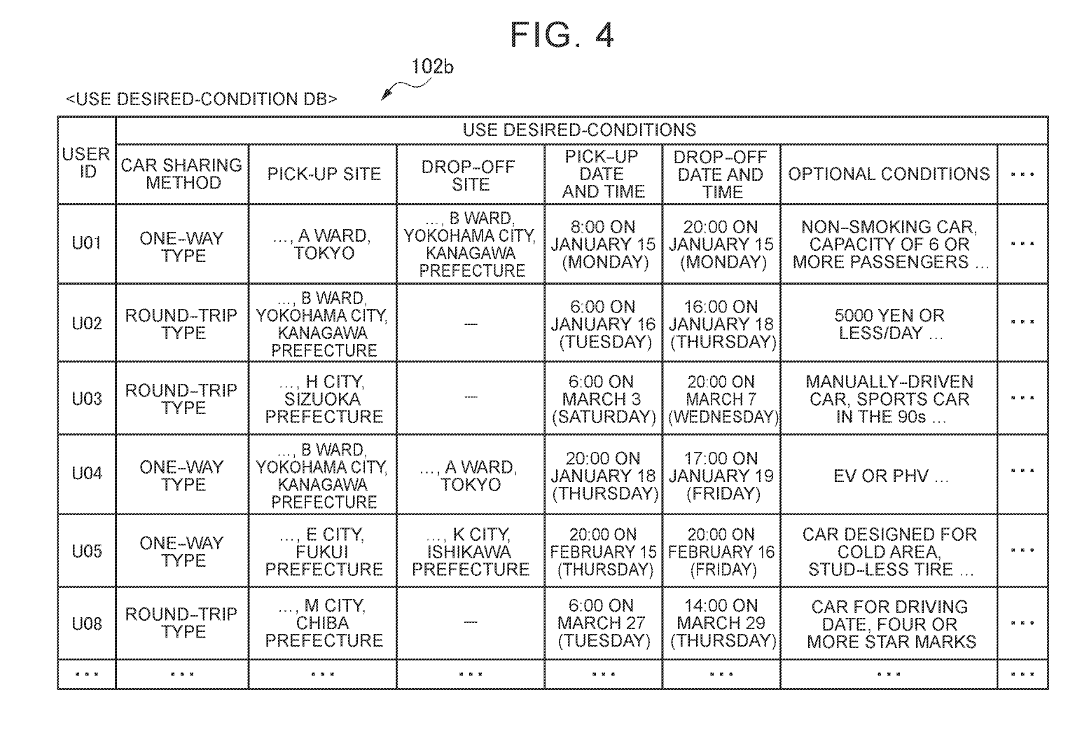

FIG. 4 is a diagram showing a specific example of the use desired-condition DB 102b. As shown in FIG. 4, the user ID (for example, the user's name), which uniquely identifies the user, and the use desired-conditions are associated with each other and registered in the use desired-condition DB 102b. As the use desired-conditions, the user-specified conditions, such as the car sharing method, pick-up site, drop-off site, pick-up date and time, drop-off date and time, and optional conditions, are set. More specifically, one of the round-trip type car sharing and the one-way type car sharing is set as the car sharing method, the information (address, latitude and longitude, etc.) indicating the site at which the user wishes to pick up the vehicle 30 is set as the pick-up site, and the information (address, latitude and longitude, etc.) indicating the site at which the user wishes to drop off the vehicle 30 is set as the drop-off site. Furthermore, the date and time on which the user wishes to start from the pick-up site is set as the pick-up date and time, and the date and time on which the user wishes to arrive at the drop-off site is set as the drop-off date and time. In addition, the conditions optionally desired by the user in using the CS service are set as the optional conditions.

In the example shown in FIG. 4, the user with the user ID “U01” has set the following use desired-conditions. That is, using “one way type” car sharing, the user wishes to pick up the vehicle at “. . . , A ward, Tokyo” at “8:00 on January 15 (Monday)” and to drop off the vehicle at “. . . , B ward, Yokohama City, Kanagawa prefecture” at “20:00 on January 15 (Monday)” (in this case, so-called drop-off), preferably with the desire that the vehicle is a “non-smoking vehicle with a capacity of 6 or more passengers, . . . ”. The user with the user ID “U02” has set the following use desired-conditions. That is, using “round-trip type” car sharing, the user wishes to pick up the vehicle at “. . . , B ward, Yokohama City, Kanagawa prefecture” at “6:00 on January 16 (Tuesday)” and to drop off the vehicle at the location where the user picks up the vehicle (that is, “ . . . , B ward, Yokohama City, Kanagawa prefecture”) at “16:00 on January 18 (Thursday)”, preferably with the desire that the fee is “5000 yen or less/day . . . ”.

Note that, if the user does not wish to specify “pickup date and time”, all or a part of the date and time may be omitted. For example, a user can set that the user has no particular desire about the pick-up time (the user may start any time) if it is possible to pick up the vehicle at “ . . . , Nagoya City, Aichi prefecture” on “March 20”.

<Use Result Information DB 102c>

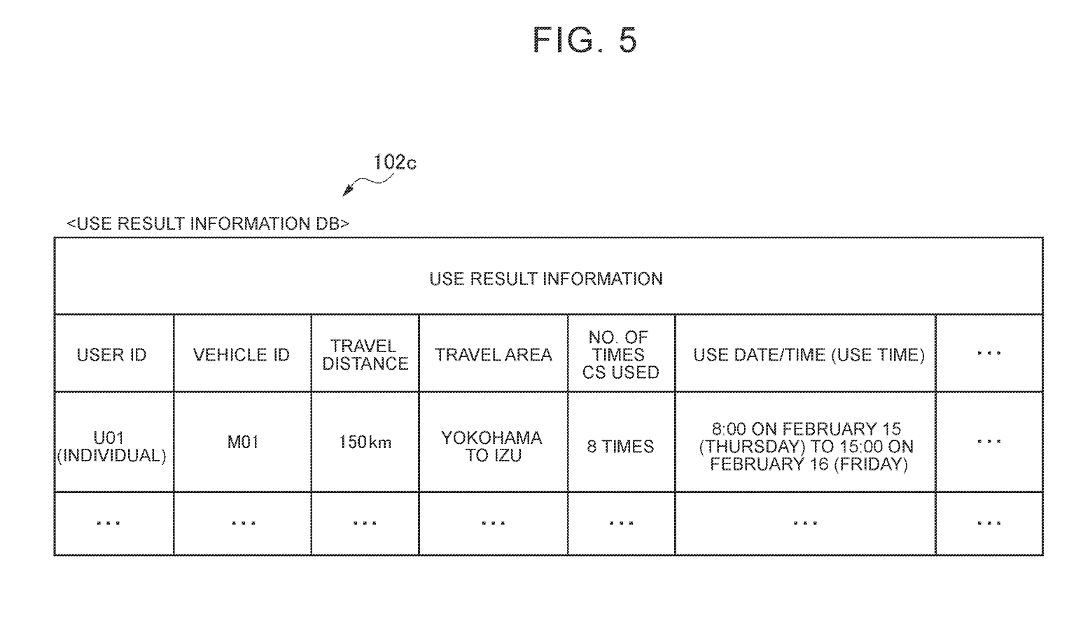

FIG. 5 is a diagram showing a specific example of the use result information DB 102c. As shown in FIG. 5, the use result information indicating the use result of the CS service is registered for each user in the use result information DB 102c.

The use result information includes the user ID that uniquely identifies each user, the vehicle ID that identifies the vehicle actually used, the travel distance, the travel area, the number of times the CS service was used in the past (actual number of times), the use date and time (use time) on which the user actually used the CS service, and so on. In the example shown in FIG. 5, the use result information indicates that the user with the user ID “U01 (individual)” used the vehicle with the vehicle ID “M01” from “8:00 on February 15 (Thursday) to 15:00 on February 16 (Friday)”, that the travel area was “Yokohama to Izu”, that the travel distance was “150 km”, and that the number of use times in the past was “8 times”. Although only the latest use result information is registered in FIG. 5 for the convenience of description, the use result information on the user for a certain period (for example, the past three years etc.) may be registered or all the use result information from user registration to the present may be registered.

<Evaluation Information DB 102d>

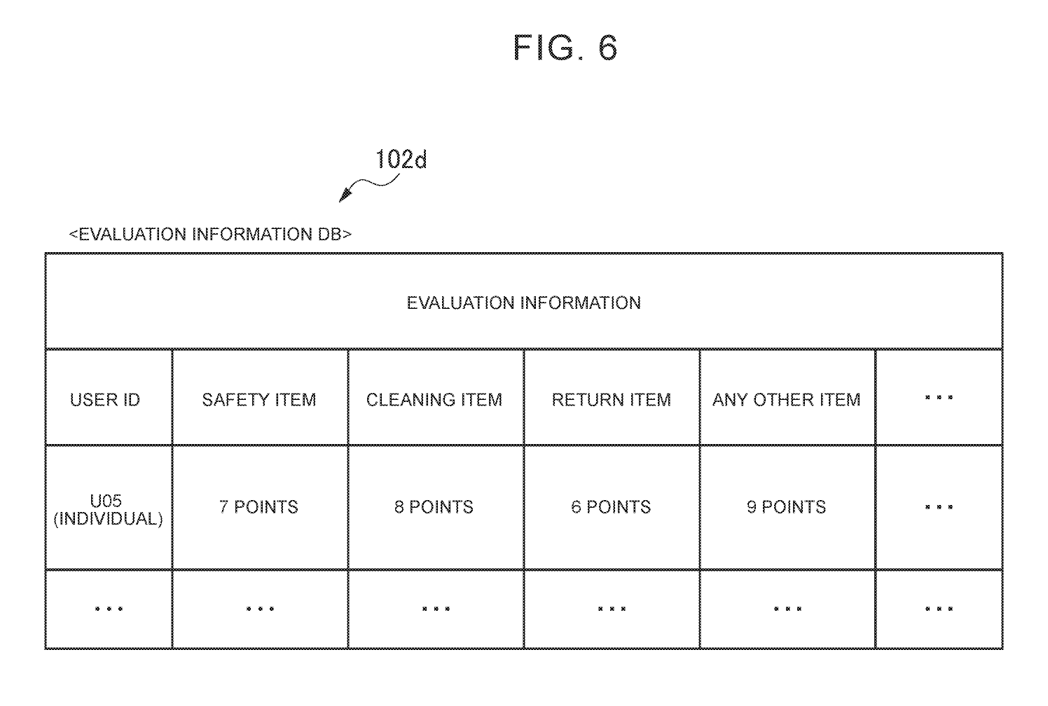

FIG. 6 is a diagram showing a specific example of the evaluation information DB 102d. As shown in FIG. 6, the evaluation information on each user (that is, the evaluation result of each user) to whom the owner's vehicle was rented is registered in the evaluation information DB 102d. This evaluation information is sent from the owner terminal 10 of each owner. It is assumed that, as the evaluation history information, the evaluation information on a user for a certain period (for example, the past three years etc.) is registered in the evaluation information DB 102d. Note that the period for which the evaluation information is registered is not limited to a certain period. For example, only the latest evaluation information may be registered in the information DB 102 or, conversely, all the evaluation information from user registration to the present time may be registered in the evaluation information DB 102d.

In the example shown in FIG. 6, as the evaluation items, the safety item, cleaning item, return item, and any other item are set in this database. For the user with the user ID “U05 (individual)”, “7 points” , “8 points”, “6 points”, and “9 points” are registered, respectively, in those items. When the vehicle is returned, each owner touches the evaluation input screen, displayed on the owner terminal 10, to enter a score (for example, a point from “0” to “10” or the like) for each evaluation item. The evaluation items are scored as follows. In the safety item, a score indicating whether the vehicle was involved in an accident or in a trouble during the rental period is set. In the cleaning item, a score indicating the degree of dirt in the vehicle interior or whether there are scratches or broken equipment is set. In the return item, a score indicating whether the vehicle has been returned within the scheduled time, whether the vehicle has been returned properly to the return location, or the like is set. In any other item, a score is set, for example, when the same vehicle is rented for a long period or the vehicle is rented at a normal rate with no discount. Note that these items are merely an example and that the evaluation items can be set or changed appropriately according to the system design.

<Service Rank DB 102e>

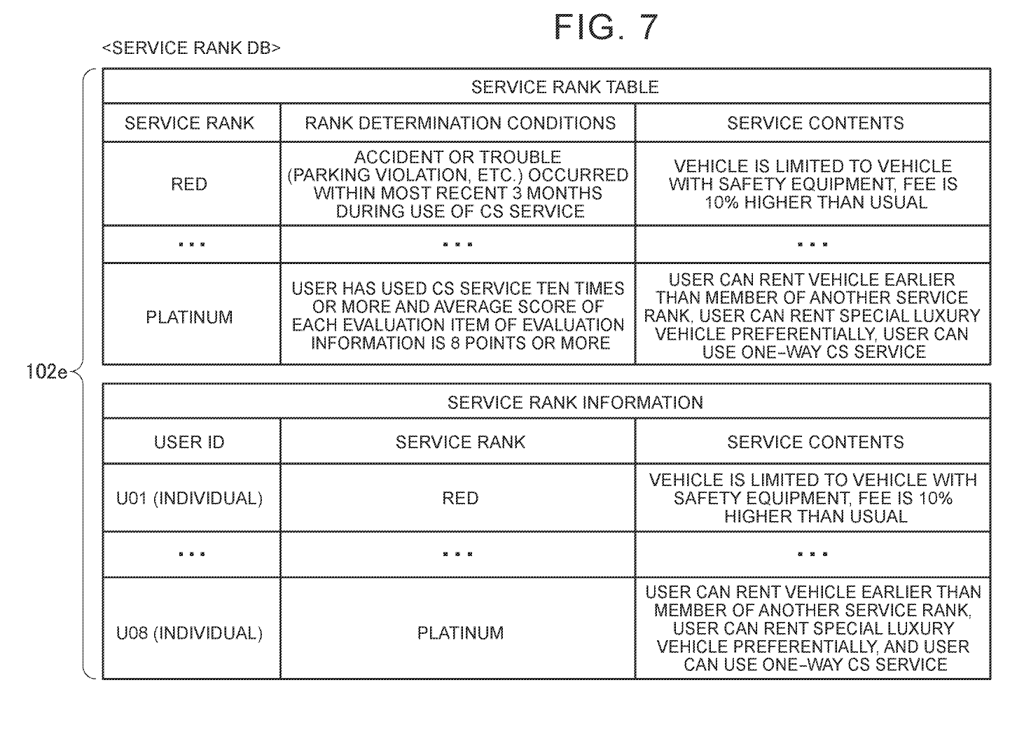

FIG. 7 is a diagram showing a specific example of the service rank DB 102e. As shown in FIG. 7, the service rank DB 102e includes the service rank table and the service rank information. The service rank table includes the service rank (“red”, “blue”, “bronze” . . . “platinum”, etc.), rank determination conditions, and service contents that are associated with each other. The service rank information indicates the service rank for each user and the service contents corresponding to that service rank.

The service rank table shown in FIG. 7 includes two examples. In the first example (top row), it is indicated that, if the rank determination conditions “an accident or a trouble (parking violation, etc.) occurred within the most recent 3 months during the use of the CS service” are satisfied, the service rank is set to “red” and that the service contents in this case are “the vehicle is limited to a vehicle with safety equipment, the fee is 10% higher than usual”. In the second example (bottom row), it is indicated that, if the rank determination conditions “the user has used the CS service ten times or more and the average score of each evaluation item of the evaluation information is 8 points or more” are satisfied, the service rank is set to “platinum” (a special service rank) and that the service contents in this case are “the user can rent a vehicle earlier than a member of another service rank, the user can rent a special luxury vehicle preferentially, and the user can use the one-way CS service”.

The service rank information shown in FIG. 7 includes two examples. In the first example (top row), for the user with user ID “U01 (individual)”, “red” is set as the service rank and “the vehicle is limited to a vehicle with safety equipment, the fee is 10% higher than usual” is set as the service contents. In the second example (bottom row), for the user with the user ID “U08 (individual)”, “platinum” is set as the service rank and “the user can rent a vehicle earlier than a member of another service rank, the user can rent a special luxury vehicle preferentially, and the user can use the one-way CS service ” is set as the service contents.

The acquisition unit 103 acquires the use result information and the evaluation information (evaluation history information) from the storage unit 102 for each user for a certain period of time (for example, past six months). The acquisition unit 103 may acquire the use result information and the evaluation information when they are updated or at any predetermined time (for example, once every week, at exact midnight on every Friday). In addition, rather than a certain period of time, the acquisition unit 103 may acquire the most recent use result information and the most recent evaluation information from the storage unit 102.

The setting unit 104 searches the service rank table, registered in the service rank DB 102e, using the use result information and the evaluation information acquired by the acquisition unit 103, as the search key. By searching the service rank table in this way, the setting unit 104 determines the service rank and finds the service contents corresponding to that service rank. After that, the setting unit 104 sets (registers) the determined service rank and its service contents in the service rank DB 102e as the service rank information on the user. For example, if it is identified that the number of times the user with the user ID “U08 (individual)” used the CS service is “15” and that the average score of each evaluation item of the evaluation information is “8.5 points”, the setting unit 104 references the service rank table and determines that the service rank should be set to “platinum” and that its service contents are “the user can rent a vehicle earlier than a member of another service rank, the user can rent a special luxury vehicle preferentially, and the user can use the one-way CS service”. After determining the service rank in this way, the setting unit 104 registers the determined service rank and its service contents in the service rank DB 102e as the service rank information on the user.

The output unit 105 notifies the user terminal 20 of each user about the service rank information registered in the service rank DB 102e. Note that the service rank information is required to be notified only to the user for whom the service rank information has been updated. Each user confirms the service rank information notified to the user terminal 20 and finds that the rank has been upgraded (for example, “bronze” to “silver”) or downgraded (for example, “platinum” to “silver”, etc.).

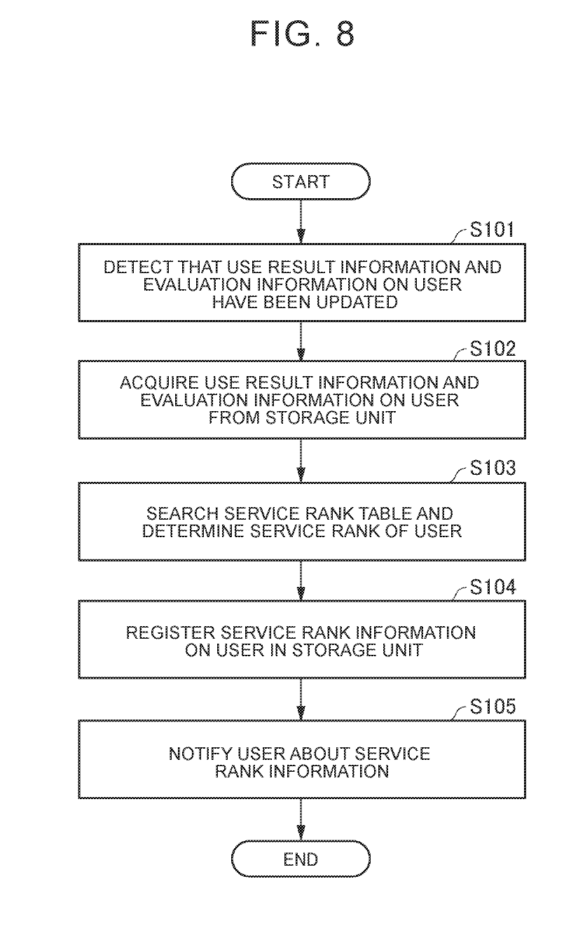

FIG. 8 is a diagram showing an example of the processing procedure performed by the information processing device 100. In the description below, it is assumed that a user has used the CS service and, as a result, the use result information and the evaluation information on the user have been changed.

In step S101, the acquisition unit 103 detects that the use result information and the evaluation information on the user have been updated.

In step S102, the acquisition unit 103 acquires the use result information on the user from the use result information DB 102c, and the evaluation information on the user from the evaluation information DB 102d.

In step S103, the setting unit 104 searches the service rank table, registered in the service rank DB 102e, using the use result information and the evaluation information on the user, acquired by the acquisition unit 103, as the search key. Then, the setting unit 104 determines the service rank based on the search result and finds the service contents of the determined service rank.

In step S104, the setting unit 104 sets (registers) the determined service rank, as well as the service contents that the user can use from the next time, in the service rank DB 102e as the service rank information. Since the actual setting method of the service rank information has already been described in detail, the description is omitted here.

In step S105, the output unit 105 notifies the user terminal 20 of the user about the service rank information registered in the service rank DB 102e. The user can confirm the service rank information, notified to the user terminal 20, to know that the rank has been upgraded (for example, “bronze” to “silver”) or downgraded (for example, “platinum” to “silver”).

As described above, the information processing device 100 in the present embodiment determines the service rank based on the use result information and the evaluation information on the user who uses the CS service and, according to the determined service rank, sets the service contents that the user can use from the next time. That is, in this embodiment, the degree of quality of the service contents the user can use from the next time depends on the determined service rank. Therefore, this embodiment encourages each user to actively use the CS service and motivates each user to enhance the user's evaluation result, making it possible to effectively promote the use of the CS service.

B. Modification

In the embodiment described above, though an owner who provides the vehicle 30 for rental use enters the evaluation information on a user, the present disclosure is not limited to this configuration. For example, in addition to (or in place of) this configuration, a user who rents a vehicle later (hereinafter also referred to as a “subsequent user”) may enter the evaluation information on a user who rented the same vehicle earlier (hereinafter also referred to as a “preceding user”). This configuration is described using an example. The questionnaire screen prompting an input of the evaluation information on the preceding user is displayed on the user terminal 20 of a subsequent user. While viewing this questionnaire screen, the subsequent user confirms the degree of dirt in the vehicle interior or whether there are scratches or broken equipment and, enters the score, determined according to the confirmation result, into the user terminal 20 as the evaluation information on the preceding user. The evaluation information on the preceding user, entered into the user terminal 20, is sent to the information processing device 100. Note that some benefits, such as a discount on the use fee or a point for upgrading the rank of service, may be given to a subsequent user who has evaluated the preceding user.

Furthermore, based on the evaluation information on a user entered by an owner who provides the vehicle 30 for rental use and/or the evaluation information on a user entered by a subsequent user, the information processing device 100 may comprehensively evaluate the user and, based on this comprehensive evaluation result, set the service contents that the user can use from the next time.

Although the service contents that a user can use from the next time is set based on the use result information and the evaluation information on the user in the embodiment described above, only the use result information on the user or only the evaluation information on the user may be used to set the service contents that the user can be use from the next time.

C. Others

In addition, a “unit” used in this specification means not only a physical component but also software-implemented processing performed by the “unit”. The processing executed by one “unit” or one device may be implemented by two or more physical components or devices or, conversely, the processing executed by two or more “units” or devices may be implemented by one physical unit or by one device.

The steps in each of the processing described above may be changed, or may be executed in parallel, as long as there is no inconsistency in the processing contents.

What is claimed is

1. A car sharing system, comprising at least one processor configured to:
acquire an evaluation result of a user who uses a vehicle; and
set contents of a car sharing service that the user can use from a next time, based on the acquired evaluation result.

2. The car sharing system according to claim 1, wherein
the at least one processor is configured to
acquire use result information with the evaluation result of the user, the use result information representing a use result of the car sharing service by the user, and
set the contents of the car sharing service that the user can use from the next time, based on the evaluation result and the use result information that are acquired.

3. The car sharing system according to claim 1, wherein
the evaluation result of the user includes at least one of an evaluation result sent from an owner of the vehicle and an evaluation result sent from a subsequent user.

4. The car sharing system according to claim I, further comprising
a memory configured to store, for each user, evaluation history information representing a history of the evaluation result, wherein
the at least one processor is configured to acquire the evaluation history information on the user for a predetermined period of time, determine a service rank of the user based on the acquired evaluation history information and, to set, according to the determined service rank, the contents of the car sharing service that the user can use from the next time.

5. The car sharing system according to claim 4, wherein
there is a service item of the car sharing service that can be used when the determined service rank is a specific service rank.

6. A method for car sharing, comprising:
acquiring an evaluation result of a user who uses a vehicle; and
setting contents of a car sharing service that the use can use from a next time, based on the acquired evaluation result.

7. The method according to claim 6, further comprising
acquiring use result information with the evaluation result of the user, the user result information representing a user result of the car sharing service by the user, and
setting the contents of the car sharing service that the user can use from the next time, based on the evaluation result and the use result information.

8. The method according to claim 6, further comprising
storing, for each user, evaluation history information representing a history of the evaluation result,
acquiring the evaluation history information on the user for a predetermined period of time,
determining a service rank of the user based on the acquired evaluation history information and,
setting, according to the determined service rank, the contents of the car sharing service that the user can use from the next time.

9. An information processing device comprising:
at least one processor; and
a storage device coupled to the at least one processor and storing program instructions which, when executed by the at least one processor, cause the information processing device to perform the method according to claim 6.

10. A non-transitory storage medium storing a program, wherein the program, when executed by a computer, causes the computer to function as:
an acquisition unit that acquires an evaluation result of a user who uses a vehicle; and
a setting unit that sets contents of a car sharing service that the user can use from a next time, based on the acquired evaluation result.
